(19) United States
(12) Patent Application Publication
(10) Pub. No.: US 2004/0256770 A1
(43) Pub. Date: Dec. 23, 2004

(54) Method of manufacturing a hardhat

(76) Inventors: Christopher Padgett, Jasper, GA (US); William B. Erb, Atlanta, GA (US)

Correspondence Address: MCANDREWS HELD & MALLOY, LTD, 500 WEST MADISON STREET, SUITE 3400, CHICAGO, IL, 60661

(21) Appl. No.: 10/600,060

(22) Filed: Jun. 20, 2003

(51) Int. Cl. B29C 51/00; B29C 45/00; B29C 37/02

(52) U.S. Cl. 264/544; 264/138; 264/161; 264/162; 264/328.1; 264/297.1; 264/297.2; 264/297.8

(57) ABSTRACT

A method of manufacturing a safety helmet, including forming, through a process of injection molding using a single mold, a basic safety helmet comprising a basic outer shell having a brim integrally formed with a dome. The brim of the basic safety helmet may have a uniform and constant width, or a variable width around a lower perimeter of the dome. The method also includes selectively removing portions of the basic safety helmet after the basic safety helmet is formed to produce a modified safety helmet.

### BACKGROUND OF THE INVENTION

The present invention generally relates to protective headwear, such as a hardhat or safety helmet that is worn, for example, by construction workers, miners, athletes, and the like. More particularly, embodiments of the present invention relate to a method of manufacturing protective headwear.

Various individuals wear safety helmets during work or athletic activities. For example, construction workers often wear hardhats while on a worksite to protect themselves from the threat of impact and/or penetration from falling objects. Similarly, various athletes, such as American football, ice hockey and lacrosse players, wear protective headgear to protect against the impact of collisions with other players, playing surface, playing boundaries (such as plexi-glass) sticks, and/or flying objects (such as a hockey puck).

Various types of safety helmets, of varying shapes, sizes and configurations, currently exist. For example, U.S. Pat. No. 6,317,895, entitled “Safety Helmet Assembly,” which issued Nov. 20, 2001 (the “'895 patent”), discloses a lightweight safety helmet that provides protection from impact and penetration. The safety helmet includes a rigid outer shell, a shock absorbing layer within the outer shell, and a shield layer fabricated from a strong and lightweight material positioned between the outer shell and the shock absorbing layer. The shield layer is preferably free to move relative to the outer shell in a direction toward the shock absorbing layer. The '895 patent is hereby incorporated by reference in its entirety.

Another example of a safety helmet is disclosed in U.S. Pat. No. 6,453,476, entitled “Protective Helmet” (the “'476 patent”), which is hereby incorporated by reference in its entirety. The '476 patent discloses a protective helmet that includes a hard outer shell and an energy-absorbing liner. The liner is made of low resilience or slow-recovery viscoelastic foam that is compression rate sensitive.

Still another example of a safety helmet is described in U.S. Pat. No. 6,260,212, entitled “Head-Protective Helmet with Geodesic Dome,” which issued Jul. 17, 2001 (the “'212 patent), which is hereby incorporated by reference in its entirety. The '212 patent discloses a helmet comprising a geodesic dome that may be combined with other elements to provide a head-protective helmet. Various safety helmet shapes, sizes, and configurations exist. Additional examples of safety helmets are described by U.S. Pat. No. 5,319,808, U.S. Pat. No. 5,619,754, U.S. Pat. No. 5,117,506, and U.S. Pat. No. 5,150,479, all of which are hereby incorporated by reference in their entireties.

Safety helmets and hardhats, such as those described and identified above, may be manufactured through a process of molding. Typically, the outer shell of each helmet is formed through a mold. Helmets of different shapes, such as different brim shapes and configurations, are typically formed through different molds. That is, the outer shell of each helmet is defined by a cavity of a mold within which the outer shell was formed. For each different shape of helmet, a different mold is typically used. The shape of the finished helmet, including the shape of the brim and other features, is defined by the shape of the corresponding mold.

For example, U.S. Pat. No. 5,609,802, entitled “Helmet Making Process” (the “'802 patent”), which issued Mar. 11, 1997, describes such a manufacturing process. The '802 patent discloses a helmet making process that includes the use of upper and lower dies. Shape molded plastic upper and lower shells are inserted into the dies. A polyurethane mixture is filled into at least one of the shells. The dies are then heated to allow the polyurethane mixture to foam completely. The semi-finished helmet is then allowed to cool. Projections from lower shells are then trimmed and surface treated to form a finished helmet. The '802 patent is hereby incorporated by reference.

The '802 patent, however, does not describe a process that allows for the manufacture of helmets having different configurations using the same mold. Rather, the finished helmet produced by the process described in the '802 patent is always the same. Additional examples of helmet manufacturing processes are described in U.S. Pat. No. 5,565,155, U.S. Pat. No. 5,298,208, and U.S. Pat. No. 4,615,438, all of which are hereby incorporated by reference in their entireties. None of the patents discussed above, however, disclose forming a variety of helmet configurations from a single mold.

U.S. Pat. No. 6,298,498, entitled “Protective Helmet System,” which issued Oct. 9, 2001 (the “'498 patent”), relates to a protective helmet system that is configured for a variety of protection classifications. The '498 patent discloses a system that reduces (a) the number of different helmets that need to be manufactured, and (b) the number of components that need to be maintained in an inventory. By reducing the number of helmets to be manufactured, and the number of components in inventory, a manufacturer saves time and resources. The reductions in the number of helmets manufactured and components in inventory are achieved through a system that is configured to allow multiple face shields to be releasably attached to the helmet, either individually or simultaneously. The '498 patent is hereby incorporated by reference in its entirety. The '498 patent discloses a modular helmet system that allows various face shields to be releasably attached to the helmet. The outer shell of the helmet disclosed in the '498 patent, however, remains unchanged. That is, the same outer shell is used with the various face shields.

Thus, a need exists for an efficient method of manufacturing hardhats and helmets of various shapes and sizes. Further, a need exists for a method that minimizes the costs of manufacturing helmets and hardhats having different shapes and sizes.

### BRIEF SUMMARY OF THE INVENTION

Certain embodiments of the present invention provide a method of manufacturing a plurality of safety helmets or hardhats, at least two of which have different shapes. The method includes forming basic hardhats from a single mold, wherein the mold is configured to form a basic hardhat comprising a basic outer shell. The method also includes selectively removing portions of the basic hardhats after the forming step to produce a plurality of modified hardhats, wherein at least two of the modified hardhats have different shapes.

### BRIEF DESCRIPTION OF SEVERAL VIEWS OF THE DRAWINGS

FIG. 1 illustrates an isometric top view of a basic safety helmet according to an embodiment of the present invention.

FIG. 2 illustrates a side view of a basic safety helmet according to an embodiment of the present invention.

FIG. 3 is a flow chart of a manufacturing process of a safety helmet according to an embodiment of the present invention.

FIG. 4 illustrates an isometric top view of a modified safety helmet according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

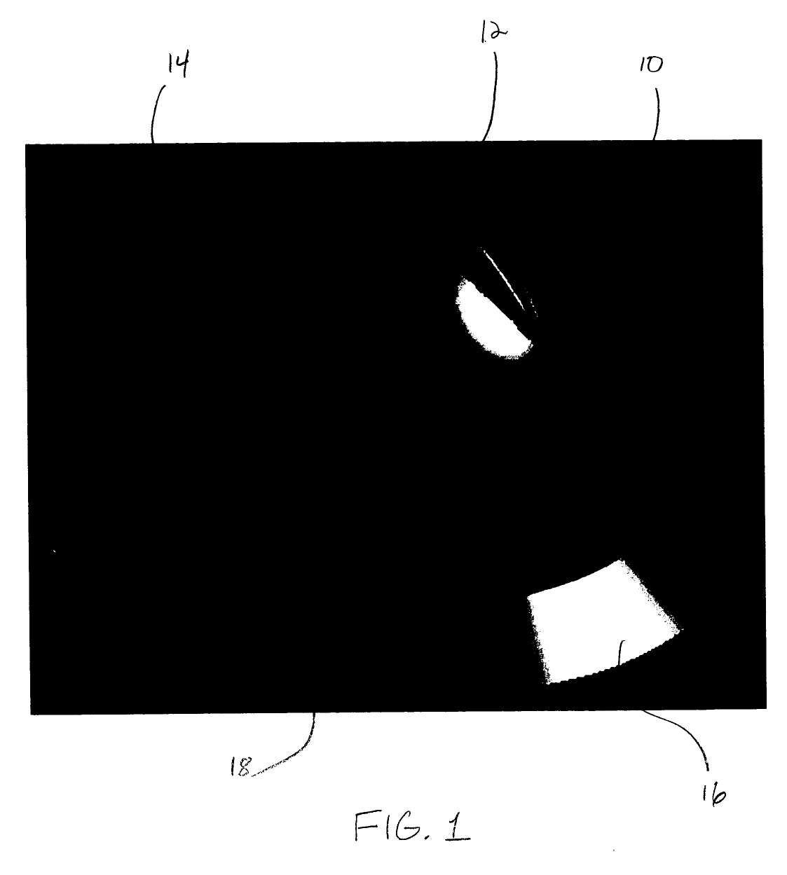

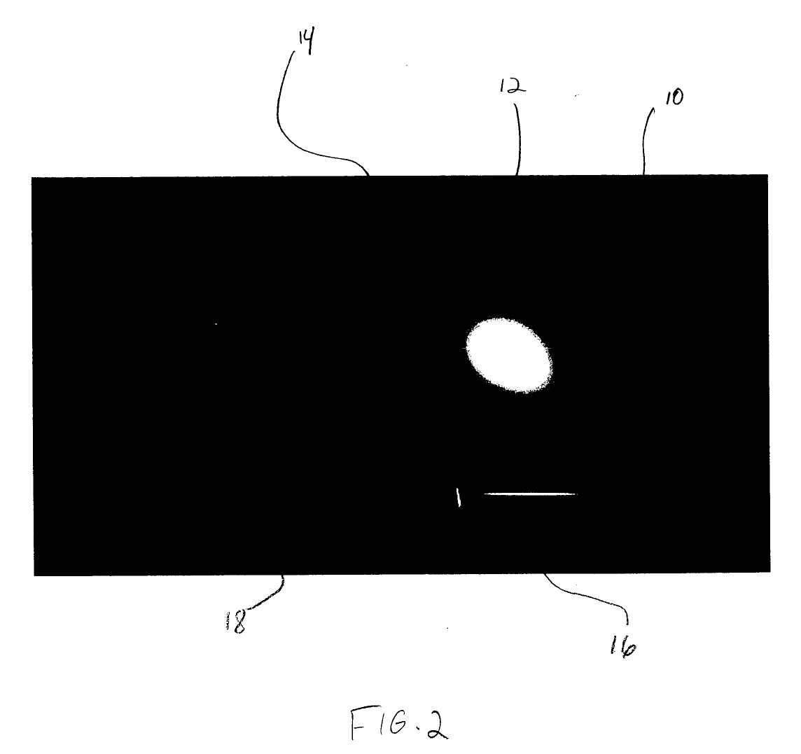

FIG. 1 illustrates an isometric top view of a basic safety helmet 10 according to an embodiment of the present invention. FIG. 2 illustrates a side view of the basic safety helmet 10. The basic safety helmet 10 may be composed of a strong, resilient polymer and includes a basic outer shell 12 having an upper portion 14 (shapes as a dome) that is shaped to form around at least a portion of a person's head. A full brim 16 is integrally formed with the upper portion 14 around a lower perimeter 18 of the upper portion 14. The full brim 16 extends radially outward from the lower perimeter 18. The full brim 16 is formed around the entire lower perimeter 18 and is uniform throughout. That is, the width W of the full brim 16 is constant at all points around the perimeter 18. Optionally, the full brim 16 may not have a constant width at all points around the perimeter. Instead, the full brim 16 may have a variable width around the perimeter 18 depending on the mold used to form the outer shell 12. Alternatively, the upper portion 14 may be integrally formed with a brim other than a full brim. That is, the basic safety helmet 10 may be formed such that a brim extends over a portion of the perimeter 18, as opposed to spanning the entire distance of the perimeter 18. Overall, the outer shell 12 is formed through a process of injection molding or other processes known in the art of safety headgear manufacturing. Optionally, the outer shell 12 may be formed through a process of thermoforming.

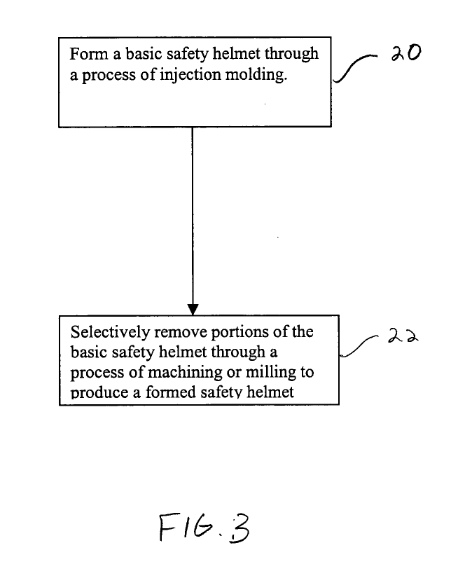

FIG. 3 is a flow chart of a manufacturing process of the safety helmet 10 according to an embodiment of the present invention. At step 20, the outer shell 12 of the basic safety helmet 10 is formed through injection molding and/or through other known processes. A single mold is used to form the basic outer shell 12. Once the basic outer shell 12 is formed, the basic outer shell 12 is secured in order to remove portions of the basic outer shell 12. That is, instead of using various molds to manufacture outer shells of various configurations, embodiments of the present invention use a single mold to produce the basic outer shell 12. At step 22, portions of the basic outer shell 12, including the full brim 16 and/or the upper portion 14, may be selectively removed, e.g., by a process of milling, machining, grinding, cutting, and the like. For example, the full brim 16 may be machined, milled, cut, or otherwise modified so that it is not uniform throughout. In general, the full brim 16 may be machined or milled so that the resulting, or modified, brim has a shape that is different from that of the original full brim 16. A lathe, band saw, grinder, laser, router, milling tool or various other tools may be used to selectively remove portions of the full brim 16. Also, for example, the basic outer shell 12 may be secured to a spindle that rotates the basic outer shell 12, thereby causing the rotating full brim 16 to rotate. The rotating full brim 16 may then engage a cutting tool, or vice versa, which selectively removes portions of the full brim 16, as per an operator's preferences.

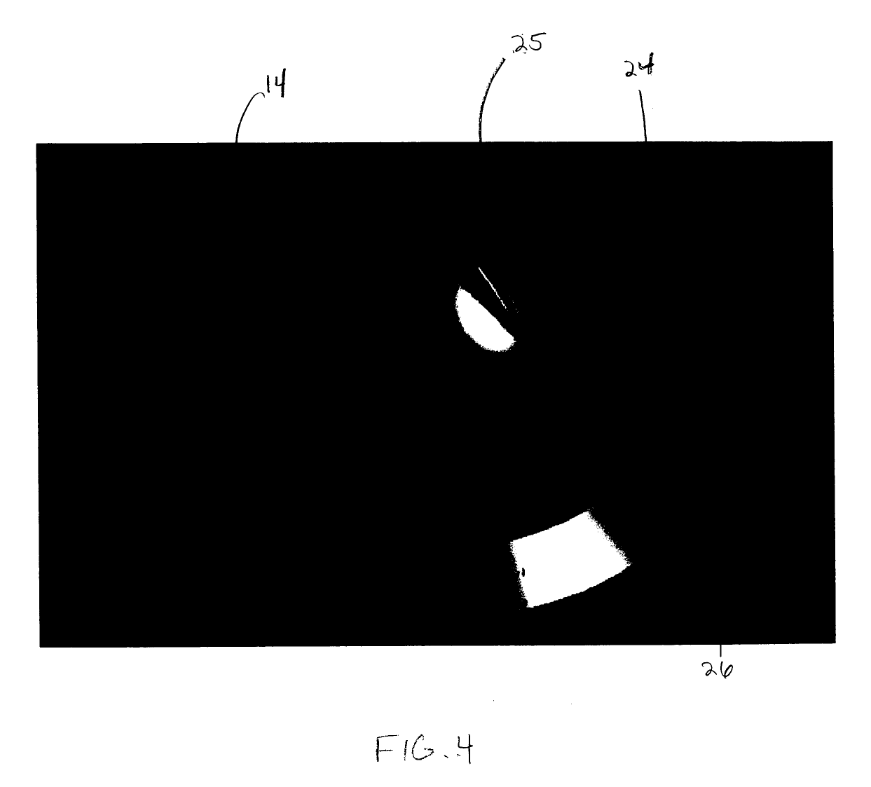

FIG. 4 illustrates an isometric top view of a modified safety helmet 24 according to an embodiment of the present invention. The modified safety helmet 24 includes the outer shell 25 having the upper portion 14 that is shaped to form around at least a portion of a person's head. The full brim 16 shown in FIG. 1 has been machined or milled such that portions of the full brim 16 have been removed, thereby producing a modified brim 26. As shown in FIG. 3, the modified brim 26 is not uniform throughout. That is, the width of the modified brim 26 at various points, e.g., W′ and W″ is not uniform and constant. Optionally, the full brim 16 may be machined to produce a modified brim that does have a uniform and constant width that is less than the width W of the full brim 16.

Additionally, portions of the upper portion 14 of the basic outer shell 12 may be machined, milled, or otherwise removed or modified after the basic outer shell 12 has been formed to produce various other safety helmet designs and configurations. For example, ear holes may be formed through the basic outer shell 12. Also, various designs, protrusions and features may be formed into, onto, and/or through the basic outer shell 12 after the basic safety helmet 10 has been formed. For example, if a football helmet is being manufactured, a team logo may be formed into the upper portion of the helmet. Overall, a single mold is used to form the basic outer shell 12. The structure of the basic outer shell 12 is modified after the basic outer shell 12 is removed from the mold (i.e., after the outer shell 12 has been formed). Other components of safety headgear, such as a shock absorbing layer, a shield layer, head band, and the like may be integrated into the safety helmet 12 before or after the machining process.

Thus, embodiments of the present invention provide an efficient method of manufacturing hardhats and helmets of various shapes and sizes. Further, embodiments of the present invention provide a method that minimizes the costs of manufacturing helmets and hardhats having different shapes and sizes. The use of a single mold to form a basic safety helmet, and the subsequent selective removal of portions of the basic safety helmet to produce various shapes, sizes and configurations of modified safety helmets, increases manufacturing efficiency and minimizes the costs associated with multiple molds.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of manufacturing a safety helmet, comprising:
forming a basic safety helmet comprising a basic outer shell having a brim integrally formed with a dome; and
selectively removing portions of the basic safety helmet after said forming step to produce a modified safety helmet.

2. The method of claim 1, wherein said forming a basic safety helmet includes forming a basic safety helmet through at least one of injection molding and thermoforming.

3. The method of claim 1, wherein the basic safety helmet is composed of a polymer.

4. The method of claim 1, wherein the full brim has a width that varies around a lower perimeter of the dome.

5. The method of claim 1, wherein the basic safety helmet is formed in a single mold.

6. The method of claim 1, wherein said selectively removing portions of the basic safety helmet includes at least one of milling portions of the basic safety helmet.

7. The method of claim 1, wherein said selectively removing portions of the basic safety helmet includes at least one of selectively removing portions of the brim to form a modified brim and modifying the dome.

8. The method of claim 1, wherein the brim is a full brim having a uniform and constant width.

9. A method of manufacturing a plurality of hardhats, at least two of the hardhats having a different shape, comprising:
forming basic hardhats from a single mold, wherein the mold is configured to form a basic hardhat comprising a basic outer shell having a brim integrally formed with a dome; and
selectively removing portions of at least one of the brim and dome of each of the basic hardhats after said forming step to produce a plurality of modified hardhats, wherein at least two of the modified hardhats have different shapes.

10. The method of claim 9, wherein said forming basic hardhats from a single mold comprises forming the basic hardhats through injection molding.

11. The method of claim 9, wherein the basic hardhats are composed of a polymer.

12. The method of claim 9, wherein the brim has one of a constant width around at least a portion of a lower perimeter of the dome and a width that varies around at least a portion of the lower perimeter of the dome.

13. The method of claim 9, wherein said selectively removing portions of the basic hardhats includes at least one of machining portions of the basic hardhats.

14. The method of claim 9, wherein said selectively removing portions of the basic hardhats includes selectively removing portions of the brim to form a modified brim, wherein the different shapes are defined by different modified brims.

15. A method of manufacturing a safety helmet, comprising:
forming, through a process of injection molding using a single mold, a basic safety helmet comprising a basic outer shell having a full brim integrally formed with a dome; and
selectively removing portions of the basic safety helmet after said forming step to produce a modified safety helmet.

16. The method of claim 15, wherein the basic safety helmet is composed of a polymer.

17. The method of claim 15, wherein the full brim has a variable width around a lower perimeter of the dome.

18. The method of claim 15, wherein said selectively removing portions of the basic safety helmet includes selectively removing portions of the full brim to form a modified brim.

19. The method of claim 15, wherein the full brim has a constant width.
